(19) United States
(12) Patent Application Publication
(10) Pub. No.: US 2010/0027082 A1
(43) Pub. Date: Feb. 4, 2010

(54) SECURITY HOLOGRAMS

(76) Inventor: John David Wiltshire, Cambridgeshire (GB)

Correspondence Address: CHRISTOPHER P. HARRIS;TAROLLI, SUNDHEIM, COVELL & TUMMINO, LLP, 1300 EAST NINTH STREET, SUITE 1700, CLEVELAND, OH, 44114, US

(21) Appl. No.: 11/814,473

(22) PCT Filed: Jan. 23, 2006
(86) PCT No.: PCT/GB2006/050017

§ 371 Date: Mar. 30, 2009

(30) Foreign Application Priority Data
Jan. 21, 2005 (GB) 0501212.5
Feb. 11, 2005 (US) 60/651651

(51) Int. Cl. G03H 1/28; G03H 1/00

(52) U.S. Cl. 359/2; 359/24

(57) ABSTRACT

This invention relates to holograms employing colour addition techniques, and to methods and apparatus for the fabrication of such holograms. The holograms are particularly useful for security applications.

A volume reflection hologram storing at least two images, the hologram comprising: a first stored image configured to replay at a first wavelength; a second stored image configured to replay at a second wavelength different to said first wavelength; wherein said first and second images at least partially overlap when replayed together; and wherein said first and second wavelengths are selected such that where said first and second images overlap they give the appearance of a colour defined by a third wavelength different to both said first and second wavelengths.

This invention relates to holograms employing colour addition techniques, and to methods and apparatus for the fabrication of such holograms. The holograms are particularly useful for security applications.

Holograms have many uses but one increasingly important application is that of security, where a hologram may be used as an anti-counterfeiting device on security documents such as passports, visas, identity cards, driver licenses, government bonds, Bills of Exchange, banknotes and the like, as well as on packaging and labelling. To improve security special visual effects may sometimes be employed such as kinetic effects, for example the appearance/disappearance of graphic elements (sometimes termed Kinegram™), or contrast/brightness variation effects, for example a graphic converting from a positive to a negative image (a Pixelgram™).

It will be appreciated, however, that there is scope for improved holographic techniques which contribute to increased security or which exhibit other desirable traits such as increased brightness and/or an improved visually aesthetic appearance. Background information relating to improved techniques for multicolour reflection holograms can be found in Improved Techniques for Multicolour Reflection Holograms, P. Hariharan, 1980 J. Opi, 11, 53-55, which refers to advantages of recording different colours in separate plates so that when the plates are aligned a multicolour image is the result.

In this specification we are particularly concerned with volume reflection holography. Broadly speaking a reflection hologram is a hologram which is constructed by interfering object and reference beams which are directed onto a recording medium from opposite sides of the medium; a volume hologram is a hologram in which the angle difference between the object and reference beams is equal to or greater than 90 degrees. Volume holograms are sometimes referred to as “thick” holograms since, roughly speaking, the fringes are in planes approximately parallel to the surface of the hologram, although in practice the thickness of the recording medium can vary significantly, say between 1 μm and 1.00 μm, typically around 7 μm.

Volume holograms are particularly useful for security applications as they are difficult to copy, although they can also be difficult to mass produce. One property of volume holograms is that when illuminated with white light at the correct angle they replay one or more stored images in a particular wavelength, determined by the spacing of a corresponding set of fringes stored within the hologram recording material. If the viewing angle is changed the brightness of the replayed image or images changes as the diffraction efficiency changes but the colour remains substantially the same. At wavelengths where the eye is particularly colour sensitive a small colour shift can sometimes be observed on tilting the hologram but it is nonetheless possible to define a colour for the replayed image (and corresponding wavelength) as being that associated with the centre or peak viewing angle at which the image is at its brightest; in practice the colour of a replayed image is clear and easy to see.

It is possible to store a plurality of different images within a single volume hologram and each of these images may be recorded such that it replays at a different wavelength; in this way it is possible to store, say, a red and green image within a single hologram. This can either be done by recording using lasers: of corresponding colours, in the foregoing example red and green lasers, or by chemical and/or physical shifting of the wavelength of a recorded image. For example, a gel-based recording material may be pre-swollen in a humidity cabinet, exposed, then dried to shrink the hologram before another image is recorded (or vice-versa); or alternatively chemical processing may be employed to add or remove material from a written hologram to change the fringe spacing, for example increasing spacing by trapping material within the recording medium by polymer cross-linking. Such techniques are well known to the skilled person.

The applicants have observed experimentally that some combinations of colours, when replayed by a hologram, can give substantially the same visual appearance as that of a single, spectrally-pure colour, and have recognised that this may be used to increase the security of a recorded hologram. More particularly the applicants have recognised that, because of the characteristics of human vision, where say red and green reflection holograms overlap the eye perceives the result as a unified yellow hologram rather than separate reddish green or greenish red images. Such a unified image appears to an observer to have been created using pure (single wavelength) yellow light and it has been recognised that this effect can be used to provide, for example, increased security against counterfeiting.

According to a first aspect of the present invention there is therefore provided a volume reflection hologram storing at least two images, the hologram comprising: a first stored image configured to replay at a first wavelength; a second stored image configured to replay at a second wavelength different to said first wavelength; wherein said first and second images at least partially overlap when replayed together; and wherein said first and second wavelengths are selected such that where said first and second images overlap they give the appearance of a colour defined by a third wavelength different to both said first and second wavelengths.

Broadly speaking, in embodiments when the first and second stored images are replayed they give rise to light of a mixture of the first and second wavelengths and this colour or wavelength mixing gives the appearance of a colour of a substantially spectrally pure third wavelength where the first and second images overlap. In preferred embodiments the colour of the third wavelength is substantially visually indistinguishable from a colour defined by a mixture of light at the first and second wavelength. Fabricating a hologram in this manner contributes to increased security since, to a casual observer, it appears as though (at least in the overlapping image portions) the hologram has been recorded using light of a single spectrally pure colour at this third wavelength whereas in fact two images have recorded at two different wavelengths. This is, however, distinguishable to a machine hologram reader which can, for example, look for the presence of the two colours separately.

Preferably the first and second images are both substantially planar, and preferably both occupy substantially the same plane when replayed. Preferably there is substantially no angular separation between the first and second images, although the appearance of the images together may change with viewing angle, for example changing in brightness or (a little) in perceived colour. In preferred embodiments the first and second images substantially correspond, to give a visual appearance (to a human observer) of a single, combined image at the colour of the third wavelength.

In one embodiment the first and second wavelengths define green and red colours respectively and the third wavelength defines a yellow colour; preferably this yellow colour is between 570 nm and 580 nm. For example a colour very similar to the yellow observed at 575 nm may be achieved by a combination of a green laser at 550 nm (for example a frequency-doubled WAG laser) and a red laser at 647 nm (Krypton red) or 633 nm (Helium neon). In another example the first and second wavelengths respectively define green and blue colours and the third wavelength define a cyan colour, in particular of a wavelength of 490 nm and 510 nm. Thus, for example, a combination of a 514 nm (Argon green) laser and a 488 nm (Argon blue) laser used to record corresponding images into a volume reflection hologram can result in a combined, replayed image which has a colour visually very similar to that of spectral cyan at 500 nm (in other arrangements Argon 455 nm may be employed in place of Argon 488 nm). The skilled person will readily understand that many other combinations of wavelengths may be employed, using routine experimentation to determine which combinations result in holographic images which where coincident and replayed at the same time give the appearance of having been recorded at a single spectral colour different from either of the actual wavelengths of the stored images. It will further be appreciated that this general principle may be extended to three or more stored images each recorded such that it replays the at a different wavelength, the three (or more) combined wavelengths being selected to give the appearance, when mixed, of a substantially spectrally pure colour.

The mechanism of the colour mixing process within the human eye is speculatively considered to result from the way in which the cells in the human retina are wired up. For example, the I-cones, which respond to greenish hues, and the L-cones which respond to reddish hues, are wired in opposition so that an L-cone inhibits an I-cone.

Embodiments of the above described hologram may be fabricated in a conventional manner using, for example, lasers of different wavelengths. Potentially, however, the recording process could be arranged so that the first and second images combine, effectively, in different proportions, for example replaying at different brightnesses, optionally providing an additional parameter which may be adjusted, say, to tune to a desired third wavelength colour match.

The invention further provides a method of fabricating a security hologram, the method comprising: storing a first image in said hologram, said first image being configured to replay at a first wavelength; and storing a second image in said hologram, said second image being configured to replay at a second wavelength, when replayed said second image at least partially overlapping said first image; wherein said first wavelength has a first colour and said second wavelength has a second colour; and wherein a mixture of light at said first and second wavelengths gives the appearance to the human eye of a spectral colour corresponding to light of a third wavelength different to said first and second wavelengths; whereby said overlapping portions of said first and second images give the appearance of a stored image portion configured to replay at said third wavelength.

The invention also provides a security hologram storing a first image configured to replay at a first wavelength, and storing a second image configured to replay at a second wavelength, when replayed said second image at least partially spatial overlapping said first image; wherein said first wavelength has a first colour and said second wavelength has a second colour; and wherein a mixture of light at said first and second wavelengths gives the appearance to the human eye of a spectral colour corresponding to light of a third wavelength different to said first and second wavelengths; whereby said overlapping portions of said first and second images give the appearance when replayed of a stored image replayed at said third wavelength.

Preferably the security hologram comprises a volume reflection hologram. Optionally one or both of the stored images may comprise a biometric image such as an image of an iris or fingerprint.

The invention further provides apparatus for fabricating a volume reflection hologram, the apparatus comprising: means for writing a first image into said hologram to replay at a first wavelength; means for writing a second image in said hologram to replay at a second wavelength, said second image and said first image to an observer at least partially spatially overlapping; and wherein said first and second wavelengths are defined such that a mixture of light at said first and second wavelengths gives the appearance to the human eye of a spectral colour corresponding to light of a third wavelength different to said first and second wavelengths.

The means for writing the first and second images may comprise, for example, a spatial light modulator such as an LCD screen coupled to an image storage/display system to display images to be written into the hologram on the screen, the screen modulating one of two interfering light beams used to create the hologram. Related techniques are described in more detail in the applicant's co-pending Application No. PCT/GB2004/050014 filed 1 Oct. 2004, priority date 1 Oct. 2003, the contents of which are hereby incorporated by reference.

These and other aspects of the invention will now be further described, by way of example, with reference to the accompanying figures in which:

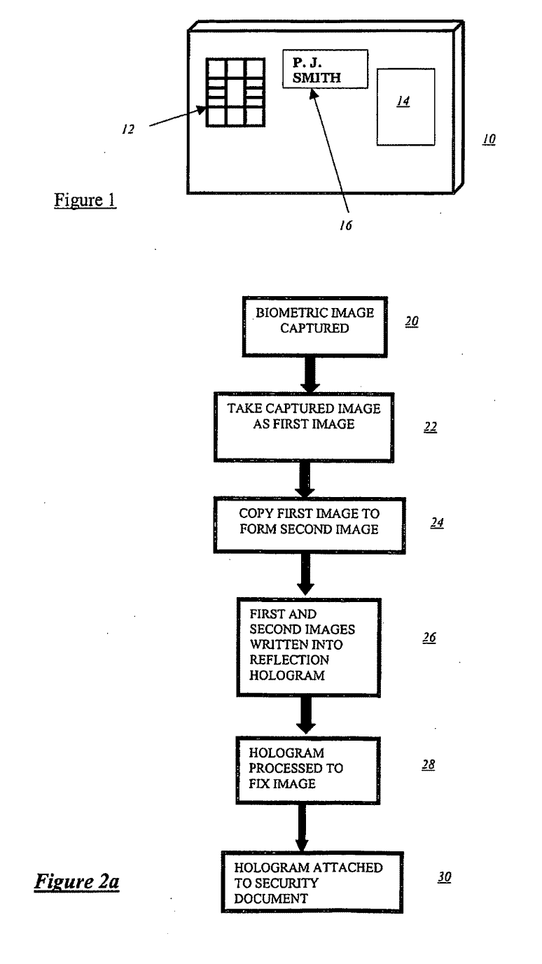

FIG. 1 shows a security document incorporating a hologram according to an embodiment of one aspect of the present invention; and a flow diagram for the fabrication of the data carrier of FIG. 1a;

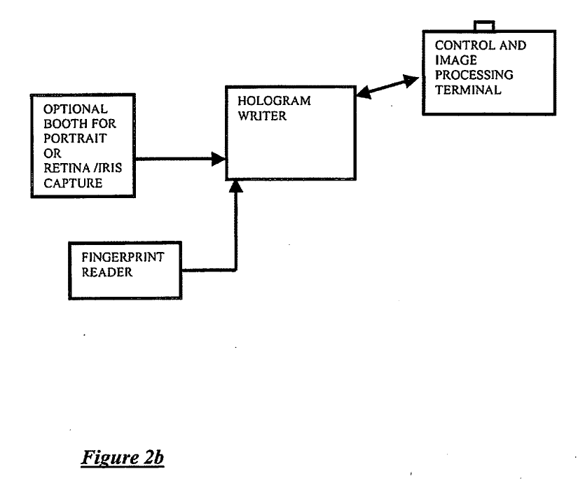

FIGS. 2a and 2b show, respectively, a flow diagram of a hologram fabrication method according to an embodiment of another aspect of the present invention, and apparatus for implementing the method;

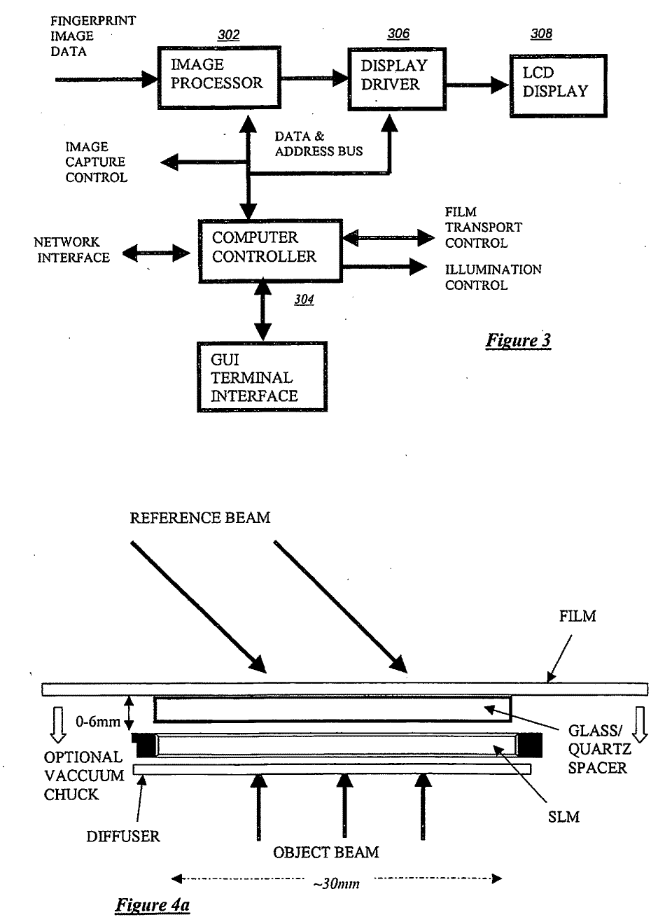

FIG. 3 shows a computer control system for the apparatus of FIG. 2b;

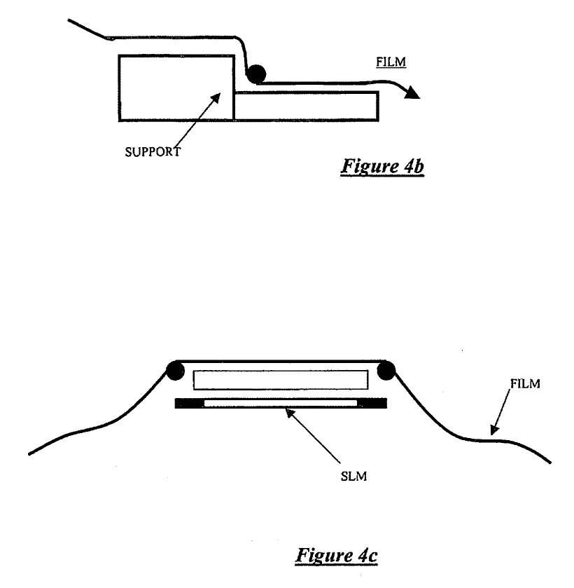

FIGS. 4a to 4c show details of a holographic writer and first and second alternative holographic film supports;

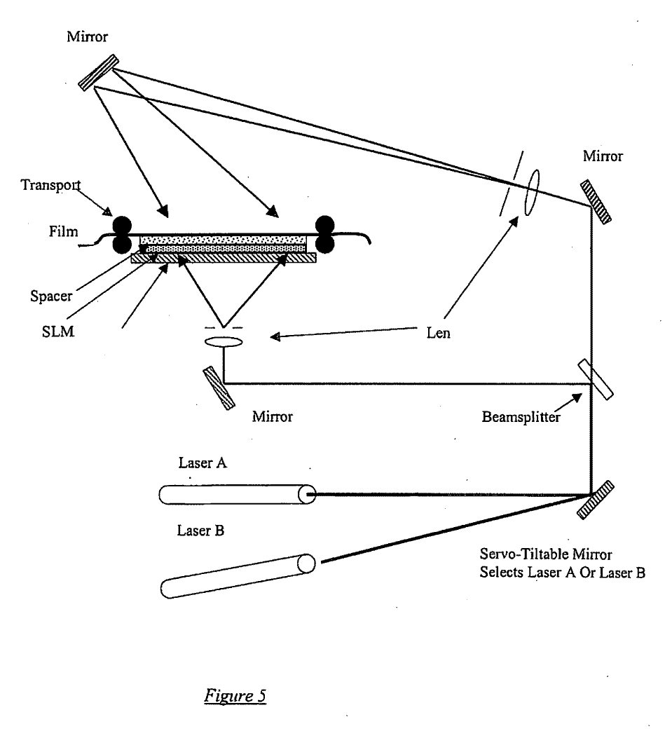

FIG. 5 shows a schematic diagram of an optical arrangement for the apparatus of FIG. 2b;

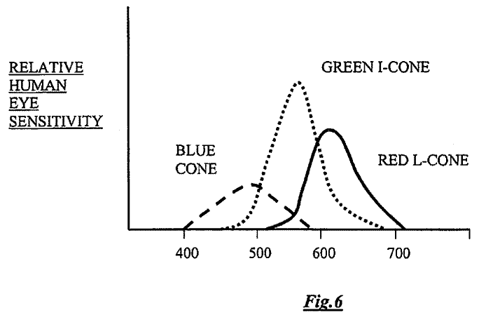

FIG. 6 shows the sensitivity of the human eye in terms of its three sets of cones;

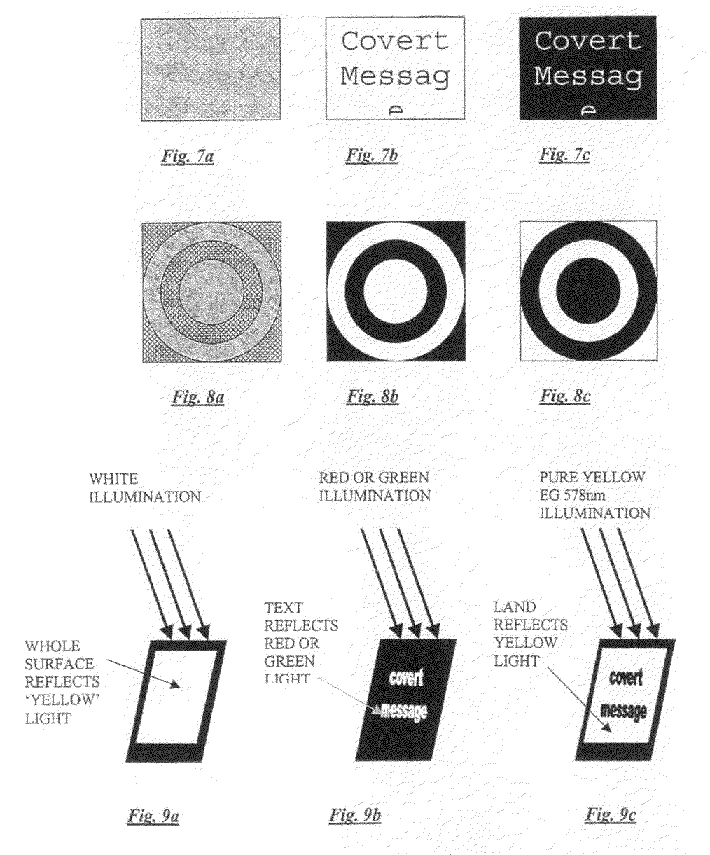

FIGS. 7a to 7c show covert text message incorporation in the surface of a security hologram;

FIGS. 8a to 8c show covert security pattern incorporation in the surface of a security hologram;

FIGS. 9a to 9c show, respectively, white, red/green, and yellow replayed images of a volume reflection hologram of FIG. 7;

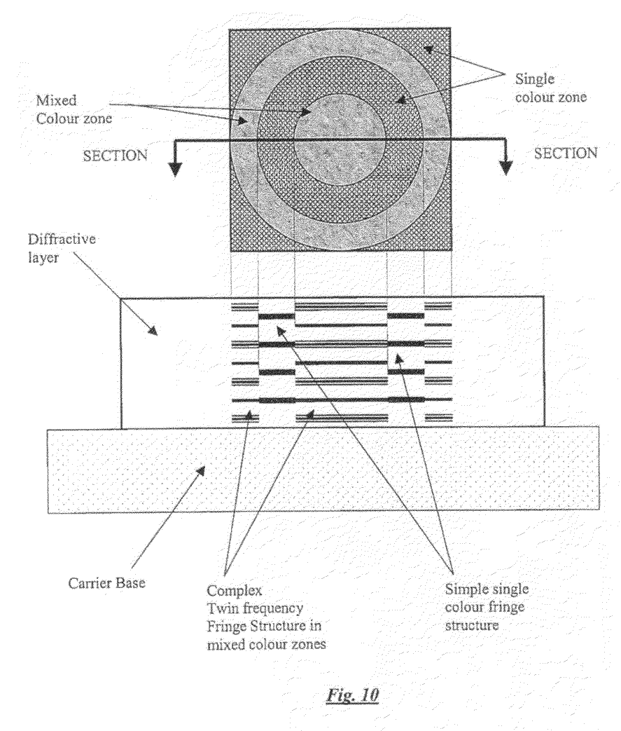

FIG. 10 shows a schematic view of a vertical cross-section through an embodiment of a hologram according to the invention showing sets of “red” and “green” fringes, according to an embodiment of the present invention:

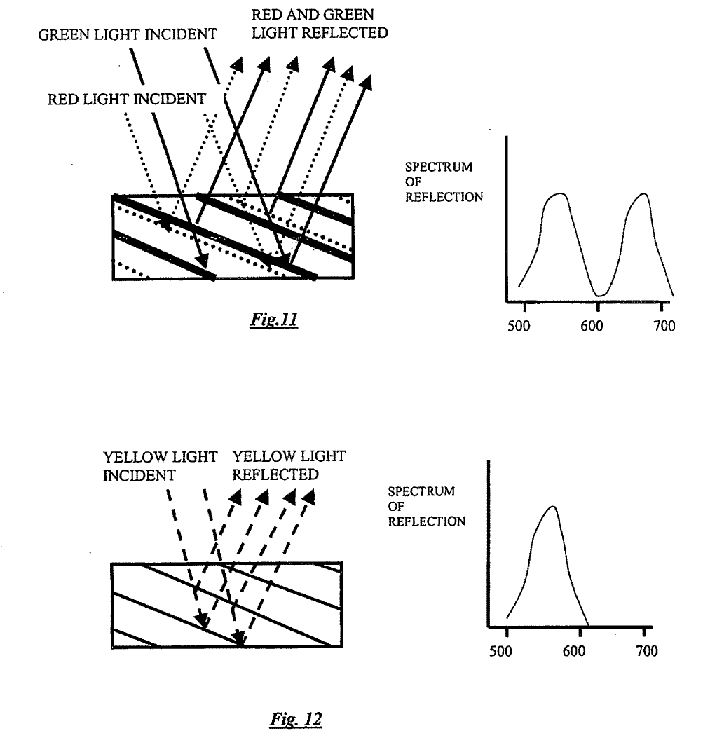

FIG. 11 shows red and green replayed images of an embodiment of a hologram according to the invention together with their reflection spectrum; and

FIG. 12 shows yellow replayed images of an embodiment of a hologram according to the invention together with their reflection spectrum.

Referring to FIG. 1, a security document 10 comprises a hologram 14 storing biometric and other data and text 16 such as a name, address, national security number and the like. Optionally, depending upon the type of document (for example with, say a credit card) an integrated circuit memory chip 12 may also be included, as described in more detail in the Applicant's PCT/GB2004/050014 (ibid). Document 10 may comprise, for example, an identity card or document, driving license, passport, credit card or any other form of identification.

Referring to FIG. 2a a hologram for card 10 may be created by capturing biometric information such as a fingerprint (step 20), taking this a first image (step 22), and copying this to create a second image (step 24), which at least partially overlaps the first and may be substantially the same as the first. Optionally other data may be created or input for storage with the hologram. At step 26 the first and second images are written into a reflective or reflection hologram, which is then processed in a conventional manner to fix the images (step 28), together with any additional data stored. The hologram is then attached to an identity document and covered with a protective layer (step 32).

FIG. 2b shows a holographic recording system. Data for recording with the hologram may be entered into the terminal and, optionally records such as write once read many (WORM) records are created locally and also, via a network, at a remote database for auditing and verification purposes. The film is preferably held securely within the hologram writer, for example accessed by a mechanical key, so that a secure film box can be removed from the writer and sent for secure chemical processing and incorporation into a document.

Referring next to FIG. 3, this shows a block diagram of a computer control system for the apparatus of FIG. 2a. Biometric data such as a fingerprint image is captured by commercial off the shelf equipment such as the BAC Securetouch USB2000 available from Bannerbridge plc of Basildon, UK and provided to an image processor 302 which, under control of a control processor 304, provides an image to display driver 306 for display on an LCD display 308, for example at SVGA resolution, at a size of approximately 30 mm². The captured input image may be converted into a binarised image, and positive and negative versions of the image may be generated, either by image processor 302 or by control computer 304.

The size and resolution of the display may be determined based upon processing power and cost. The LCD display acts as a spatial light modulator as described below with reference to FIG. 4a and thus preferably allows illumination through the device. Typically such a display comprises a micrometer thick sheet of polarising material followed by electrically configurable liquid crystal material. The LCD display may be of a type which has permanently on or off pixels rather than pixels which are refreshed, for example a ferroelectric liquid crystal device so that the pixels stay in either an on or an off (black or white) state for the duration of the image recordal, typically around two seconds. Alternatively a conventional, raster scanned display may be employed. A suitable LCD display is available from Central Research Laboratories Ltd of London, UK, for example model SVGA2 monochrome transmission LCD. An LCD display without an in-built polariser may be employed with plane polarised laser illumination, which in effect provides approximately 50% more light.

The two images for simultaneous replay by the volume reflection hologram are preferably recorded using different coloured lasers. Other means of creating the two different colours in the hologram include chemical or physical expansion of the film layer prior to exposure, and adjustment of the final thickness of the hologram layer during chemical processing of the film. For example the developer and bleaching solution for silver halide materials may be designed/selected to produce the desired colours in the final image. The layer properties of the selected recording film also affect the colour reconstruction of the stored images.

The hologram recording medium may comprise any conventional hologram recording medium including, but not limited to, dichromated gelatine (DCG), silver halide, and photo-polymer based materials.

Referring next to FIG. 4a this shows an optical configuration of the spatial light modulator and film. The spatial light modulator may be substantially adjacent the film or may be spaced apart from the film by a glass or quartz spacer. Spacers of 2, 4 or 6 mm may be employed, optionally mechanically selectable oh the control of the computer controller 304 in order to record images at different planes within the hologram. The maximum adjustment of the spacing between the spatial light modulator and film is determined by the coherence length of the laser, and is typically a few mm to a few cm (say in the range 1 mm to 30 mm, possibly up to 100 mm) for a diode laser (since, as shown later in FIG. 5, optical path lengths from the laser for the object and reference beams are preferably substantially matched).

Preferably the arrangement includes a diffuser prior to the spatial light modulator comprising, for example, ground glass or substantially non-birefringent plastic material such as polycarbonate or polyester film. Such diffusers are available from Lee Filters in the UK. The diffuser does not destroy the hologram since the differences in optical path lengths to the film from diffused rays originating from a point on the diffuser is very small, but the diffuser has the effect of providing a hologram with a speckle pattern rather than a so-called shadowgram which appears shiny like a mirror.

Many mechanical schemes may be employed for holding the film in close proximity to the spatial light modulator or spacer depending, for example, on whether sheet fed or roll fed film is employed. FIGS. 4b and 4c show two examples of film transport mechanisms; for sheet film a sheet feeder may be employed; optionally a vacuum chuck may also be used to ensure the holographic recording material bears against the spatial light modulator or spacer. In a less preferred arrangement a mounting frame holds the SLM and/or spacer in a fixed or controllable spatial relationship with respect to the film. In any of the above arrangements index matching or interface coupling temporary adhesive may be employed if necessary.

FIG. 5 shows, one example of an optical configuration for the apparatus of FIG. 2b. In particular this optical configuration shows how either laser A (say; red, for example Krypton 647 nm or HeNe 633 nm) or laser B (say, green, for example a 532 nm frequency doubled Nd-YAG laser, or 550 nm dye laser) may be selected for recording the respective first and second stored images in a volume reflection hologram, by tilting a mirror between two alternative positions, for example under servo control. In this way two different images can be recorded, each with a different colour (red and green), but both in substantially the same plane (when replayed) with reference to the plane of the recording material. Where the two images are coincident, on replay, rather than separate red and green images being seen the visual appearance is that of a distinct colour, yellow, having neither a reddish nor a greenish tint. This yellow approximately corresponds to a spectrally pure 575 nm yellow.

When defining whether two colours are visually distinguishable (to a human observer) the CIE (Commission de L'Eclarage) difference between two colours, ΔE, may be employed. Here:

ΔE=√((ΔL*)²+(Δa*)²+(Δb*)²)

where the L*, a* and b* values represent the lightness, red-to-green and blue-to-yellow values of the two colours. Thus a ΔE value of 1 or more may be taken as visible (ΔE equal to or less than 1.0 assumed not visible), or a ΔE of 0.1 may be taken as not corresponding to a visible colour difference, and ΔE equal to or greater than 0.1 assumed not visible (although ΔE does not exactly correspond to a visual assessment of a colour difference for all colours). In embodiments two colours are considered visually distinguishable if they have a CIE colour difference of <0.1, <0.5, or <1.0.

In FIG. 6, the sensitivity of the human eye is shown in terms of its three sets of cones, which it is believed are responsible for the perception of colour. Unlike the highly monochromatic behaviour characteristic of thick volume reflection holograms, these colour detectors in the eye each have a broad range of sensitivity.

Accordingly, an orange or yellow stimulus will affect both the ‘green’ and ‘red’ cones, so that the brain is basically unable to distinguish between illumination by simultaneous red and green irradiation, and a single source in the wavelength range central to those colours, for example in the area of 575-595 nm.

It is clear from the curve for the green cones that these have a higher total sensitivity than the red, and especially the blue cones. However, the hologram origination system can cope with satisfying this sensitivity imbalance of the eye, by allowing for higher efficiency of the recording of the red grating component, than for the green grating component.

A similar effect can by achieved at the blue end of the visible spectrum. A chosen ‘cyan’ equivalent single spectral colour between say 495-505 nm can be selected such that its visual stimulus affects both the blue and green cones in a way indistinguishable to the brain from the effect of a pair of stimuli acting at say 458 and 532 nm. The adjustment of all of these colours en bloc to the most effective centre of wavelength to optimally facilitate the required effects can be achieved by judicious selection of laser and chemistry techniques.

In one embodiment of the technique, diffractive lettering perceived by the human eye as yellow in colour, achieved by the mixing of red and green light, occupies space within a land area perceived as a similar colour, but in this case achieved by a narrow-band reflective diffraction of a pure spectral yellow colour of a wavelength between 575 and 595 nm for example.

The exposure of the holographic image components may achieved with the use of various lasers, such as HeNe 633 nm and Nd:YAG second harmonic 532 nm and a Krypton 568 nm or HeNe 594 nm, or alternatively be chemical or physical pre- or post-treatment of the recording layer as has been known in the art, or by a mixture or combination of these methods.

Alternatively, colours at the opposite end of the visible spectrum could be used for the purpose. Thus Argon lasers at 458 nm or 488 nm could be used to produce blue components to achieve mixing from Argon 514 nm or Nd:YAG second harmonic at 532 nm. The result is that blue and green colour components exposed by the blue argon lines and the Nd:YAG are mixed in the body of the lettering and have a very similar colour to land areas exposed at 514 nm and chemically moved to replay at 500-510 nm which corresponds to a spectral equivalent of the cyan mixture.

Advantageously, this text may be very small, e.g. less than 1 mm high, and thus may be even less apparent to the casual observer viewing the hologram in white light illumination.

Landis and Gyr have a “microtext” technique in their “kinegram” diffraction grating security systems to provide a secret security advantage by the use of lettering so small that a small lens is required to verity the text, which is covert solely be its minuscule dimensions.

However, the revelation of the covert code, by the use of illumination of a single spectral colour, which by virtue of the narrow bandwidth of the reflective diffraction associated with thick volume holograms, provides now a powerful interrogation system for the security hologram at very low cost.

Such illumination could, but need not necessarily, be provided by laser since no special coherence qualities are required to reconstruct the Lippmann hologram, so that monochromatic LED, or filtered white light can be used to illuminate the finished security hologram and reveal the covert information.

In FIG. 7, the diagram 7a shows a schematic of the intended covert text message incorporation in the surface of a security hologram. The FIGS. 7b and 7c show the artwork separations used for separate image exposures in the two visually substantially indistinguishable colours.

FIG. 8a shows a similar schematic in the case where the covert security code is in the form of a pattern rather than a text message. Such a surface pattern could typically form the surface surround to a main overt image component such as a corporate logo, which may typically be recorded in a completely separate contrasting colour, with a view to being an eye catching and visually dominant feature of the holographic security device.

It is common within the hologram security industry, to provide within a single hologram a number of separate component images to provide a range of visual and covert features which can be used for verification by the layperson, a trained observer, or at the forensic level in the laboratory, to establish whether a security device is genuine. This method is ideally suited to this style of design.

In FIG. 9a, the effect of illuminating the hologram with artwork derived from FIG. 7, with white light is shown when viewed by the human eye without any filter devices. The whole hologram surface appears to illuminate in a single homogeneous yellow or cyan colour and the observer detects little or no detail within the surface.

However, the effect of illuminating with either red (630-670 nm) or green (530-560 nm) or pure spectral yellow 575-595 nm is that the text is revealed with a positive illumination as in FIG. 9b or the land or background area is illuminated as in FIG. 9c to reveal the covert, text information.

Alternatively, the use of white light incident light is possible such that the code is revealed only when viewed through narrow bandpass filters in red, green or yellow such that component of the selectively diffracted light are attenuated or transmitted.

In FIG. 10, the difference is demonstrated between the holographic fringe microstructures in the zones of the holographic image, relating to the single wavelength and twin wavelength recording zones of the hologram. The fringes shown equate to modulation of the refractive index and it will be imagined that the twin structure results in a complex wave function index profile which is to some extent less diffraction efficient that the zone contain a single simple modulation profile. It is possible, however, to compensate this inherently lower diffraction efficiency by changing the exposure conditions of the two zones in order to balance the levels of light diffracted by the two alternative microstructures, such that they produce similar levels of reflection in the finished hologram. Such compensation can be achieved by precise control of the exposure times and beam ratios of the various image components.

FIG. 11 demonstrates the mode of diffractive reflection from the twin wavelength interference recording within the volume of the hologram recording material. Such volume recording materials are Silver halide fine grain gelatin based emulsion, photo-polymer material, or dichromated gelatin, but are not necessarily limited to those materials. Each fringe structure, which may in the case of silver halide for example be recorded simultaneously with twin laser wavelengths or alternatively consecutively with twin laser wavelengths or by the use of a single wavelength with intermediate chemical treatment between the consecutive exposures in order to modify the thickness of the recording layer and thus adjust the fringe frequency of the final dry hologram at reconstruction in order to provide a plurality of colours. Such technique is known in the art as pseadocolour holography.

FIG. 12 conversely shows the simple fringe structure achieved with a single laser exposure and this effect could be achieved by for example the use of a yellow krypton laser as described above or by the use of a more distant laser line with chemical adjustment of the reconstruction colour prior to laser exposure or subsequent layer thickness adjustment at processing. The spectrum of reconstructed image light in FIG. 12 shows a narrow peak of wavelength distribution converse to the twin peaks shown in FIG. 11. Referring again to FIG. 6 it is clear that both the red and green cones will respond to the reflected yellow light in FIG. 12, with the effect that the viewer is unable to distinguish this spectrum from that provided by the twin peaks represented in FIG. 11. Thus to the unaided human observer, it will be difficult to detect any security information present in the holographic image whereas electronic detection systems or visual examination with the aid of filters or monochromatic light sources will readily detect the covert information.

The effect of storing covert information in the hologram is not limited of course to geometric patterns or text and could, for example equally be used to disguise bar codes, fingerprint or other biometric information, or any other two or three dimensional graphics in a security hologram.

No doubt many other effective alternatives will occur to the skilled person and it will be understood that the invention is not limited to the described embodiments but encompasses modifications apparent to those skilled in the art lying within the spirit and scope of the claims appended hereto.

1-11. (canceled)

12. A volume reflection hologram storing at least two images, the hologram comprising:
a first stored image configured to replay at a first wavelength;
a second stored image configured to replay at a second wavelength different to said first wavelength;
wherein said first and second images at least partially overlap when replayed together; and
wherein said first and second wavelengths are selected such that where said first and second images overlap they give the appearance of a colour defined by a third wavelength different to both said first and second wavelengths.

13. A volume reflection hologram as claimed in claim 12 wherein said colour of said third wavelength is substantially visually indistinguishable from a colour defined by a mixture of said first and second wavelengths.

14. A volume reflection hologram as claimed in claim 12 wherein said first wavelength defines a green colour, said second wavelength defines a red colour, and said third wavelength defines a yellow colour.

15. A volume reflection hologram as claimed in claim 14 wherein said third wavelength is between 570 nm and 580 nm.

16. A volume reflection hologram as claimed in claim 12 wherein said first wavelength defines a green colour; said second wavelength defines a blue colour, and said third wavelength defines a cyan colour.

17. A volume reflection hologram as claimed in claim 16 wherein said third wavelength is between 490 nm and 510 nm.

17. A volume reflection hologram as claimed in claim 16 wherein said third wavelength is between 490 nm and 510 nm.

18. A volume reflection hologram as claimed in claim 12 wherein said first and second images substantially correspond to give a visual appearance to a human of a single, combined image at said colour of said third wavelength.

19. A security document or bank note incorporating the volume reflection hologram of claim 12.

20. A method of fabricating a security hologram, the method comprising:
storing a first image in said hologram, said first image being configured to replay at a first wavelength; and
storing a second image in said hologram, said second image being configured to replay at a second wavelength, when replayed said second image at least partially overlapping said first image;
wherein said first wavelength has a first colour and said second wavelength has a second colour; and
wherein a mixture of light at said first and second wavelengths gives the appearance to the human eye of a spectral colour corresponding to light of a third wavelength different to said first and second wavelengths,
whereby said overlapping portions of said first and second images give the appearance of a stored image portion configured to replay at said third wavelength.

21. A security hologram storing a first image configured to replay at a first wavelength, and storing a second image configured to replay at a second wavelength, when replayed said second image at least partially spatial overlapping said first image;
wherein said first wavelength has a first colour and said second wavelength has a second colour; and
wherein a mixture of fight at said first and second wavelengths gives the appearance to the human eye of a spectral colour corresponding to light of a third wavelength different to said first and second wavelengths;
whereby said overlapping portions of said first and second images give the appearance when replayed of a stored image replayed at said third wavelength.

22. Apparatus for fabricating a volume reflection hologram, the apparatus comprising:
means for writing a first image into said hologram to replay at a first wavelength;
means for writing a second image in said hologram to replay at a second wavelength, said second image and said first image to an observer at least partially spatially overlapping; and
wherein said first and second wavelengths are defined such that a mixture of light at said first and second wavelengths gives the appearance to the human eye of a spectral colour corresponding to fight of a third wavelength different to said first and second wavelengths.
